(19) United States
(12) Patent Application Publication
(10) Pub. No.: US 2015/0022120 A1
(43) Pub. Date: Jan. 22, 2015

(54) LIGHT EMITTING DIODE APPARATUS WITH OVER CURRENT PROTECTION FUNCTION AND SYSTEM HAVING THE SAME

(71) Applicant: Energy Pro Technology Co., LTD., Yilan County (TW)

(72) Inventor: Po-Nien KO, Yilan County (TW)

(73) Assignee: Energy Pro Technology Co., LTD., Yilan County (TW)

(21) Appl. No.: 14/293,655

(22) Filed: Jun. 2, 2014

(30) Foreign Application Priority Data
Jul. 16, 2013 (TW) 102125337

(51) Int. Cl. H05B 33/08

(52) U.S. Cl. CPC H05B 33/0884
USPC 315/307

(57) ABSTRACT

A switchable constant current constant voltage supply unit outputs a constant current to drive a plurality of light emitting diode apparatuses when voltages of the light emitting diode apparatuses are not greater than a threshold voltage detected by a voltage detection unit. The switchable constant current constant voltage supply unit outputs a constant voltage to drive the light emitting diode apparatuses when the voltages of the light emitting diode apparatuses detected by the voltage detection unit are greater than the threshold voltage. Moreover, the light emitting diode apparatus includes a positive temperature coefficient thermistor or a polymeric positive temperature coefficient thermistor.

### BACKGROUND OF THE INVENTION

1. Field of the Invention

The present invention relates to a light emitting diode apparatus and a system having the same, and especially relates to a light emitting diode apparatus with over current protection function and a system having the same.

2. Description of the Related Art

Currently there are three kinds of methods for driving a plurality of light emitting diode apparatuses in parallel, wherein the light emitting diode apparatus comprises a plurality of light emitting diodes in series.

The first method for driving the light emitting diode apparatuses is to use a constant voltage. A current limiting resistor is arranged in the back of the light emitting diode apparatus to protect the light emitting diodes. Therefore, the power is dissipated and the efficiency is not high. Moreover, a single light emitting diode damage can cause that the voltage of the light emitting diode apparatus is decreasing and the current of the light emitting diode apparatus is increasing. The light emitting diodes are heating, the light failure is increasing and the light emitting diodes are damaged easily.

The second method for driving the light emitting diode apparatuses is to use a constant current. The other light emitting diode apparatus in parallel have to share the current if a single light emitting diode apparatus is damaged. Therefore, the light emitting diodes are heating, the light failure is increasing and the light emitting diodes are damaged easily.

The third method for driving the light emitting diode apparatuses is to use different constant currents for different light emitting diode apparatuses. However, the cost of this method is increasing.

Therefore, currently the methods for driving the light emitting diode apparatuses in parallel will damage other normal light emitting diodes when a single light emitting diode or a single light emitting diode apparatus is damaged. Or the cost of the solution (for example, the third method mentioned above) is too expensive.

### SUMMARY OF THE INVENTION

In order to solve the above-mentioned problems, an object of the present invention is to provide a light emitting diode apparatus with over current protection function.

In order to solve the above-mentioned problems, another object of the present invention is to provide a light emitting diode system with over current protection function.

In order to achieve the object of the present invention mentioned above, the light emitting diode apparatus is applied to a switchable constant current constant voltage supply apparatus. The switchable constant current constant voltage supply apparatus comprises a switchable constant current constant voltage supply unit and a voltage detection unit. The light emitting diode apparatus comprise a plurality of light emitting diodes and a positive temperature coefficient impedance component. The light emitting diodes are connected in series and are electrically connected to the switchable constant current constant voltage supply unit and the voltage detection unit. The positive temperature coefficient impedance component is electrically connected to the switchable constant current constant voltage supply unit, the voltage detection unit and the light emitting diode. A plurality of the light emitting diode apparatuses are connected in parallel and are electrically connected to the switchable constant current constant voltage supply unit and the voltage detection unit. The voltage detection unit detects a voltage of the light emitting diode apparatus and then informs the switchable constant current constant voltage supply unit of the detected voltage. The switchable constant current constant voltage supply unit outputs a constant current to drive the light emitting diode apparatuses when the voltage of the light emitting diode apparatus detected by the voltage detection unit is not greater than a threshold voltage. The switchable constant current constant voltage supply unit outputs a constant voltage to drive the light emitting diode apparatuses when the voltage of the light emitting diode apparatus detected by the voltage detection unit is greater than the threshold voltage.

In order to achieve another object of the present invention mentioned above, the light emitting diode system comprises a switchable constant current constant voltage supply apparatus and a plurality of light emitting diode apparatuses. The light emitting diode apparatuses are connected in parallel and are electrically connected to the switchable constant current constant voltage supply apparatus. The switchable constant current constant voltage supply apparatus comprises a switchable constant current constant voltage supply unit and a voltage detection unit. The switchable constant current constant voltage supply unit is electrically connected to the light emitting diode apparatuses. The voltage detection unit is electrically connected to the light emitting diode apparatuses and the switchable constant current constant voltage supply unit. The light emitting diode apparatus comprise a plurality of light emitting diodes and a positive temperature coefficient impedance component. The light emitting diodes are connected in series and are electrically connected to the switchable constant current constant voltage supply unit and the voltage detection unit. The positive temperature coefficient impedance component is electrically connected to the switchable constant current constant voltage supply unit, the voltage detection unit and the light emitting diode. The voltage detection unit detects a voltage of the light emitting diode apparatus and then informs the switchable constant current constant voltage supply unit. The switchable constant current constant voltage supply unit outputs a constant current to drive the light emitting diode apparatuses when the voltage of the light emitting diode apparatus detected by the voltage detection unit is not greater than a threshold voltage. The switchable constant current constant voltage supply unit outputs a constant voltage to drive the light emitting diode apparatuses when the voltage of the light emitting diode apparatus detected by the voltage detection unit is greater than the threshold voltage.

### BRIEF DESCRIPTION OF DRAWING

FIG. 1 shows a block diagram of the light emitting diode apparatus with over current protection function of the present invention.

FIG. 2 shows a block diagram of the light emitting diode system with over current protection function of the present invention.

### DETAILED DESCRIPTION OF THE INVENTION

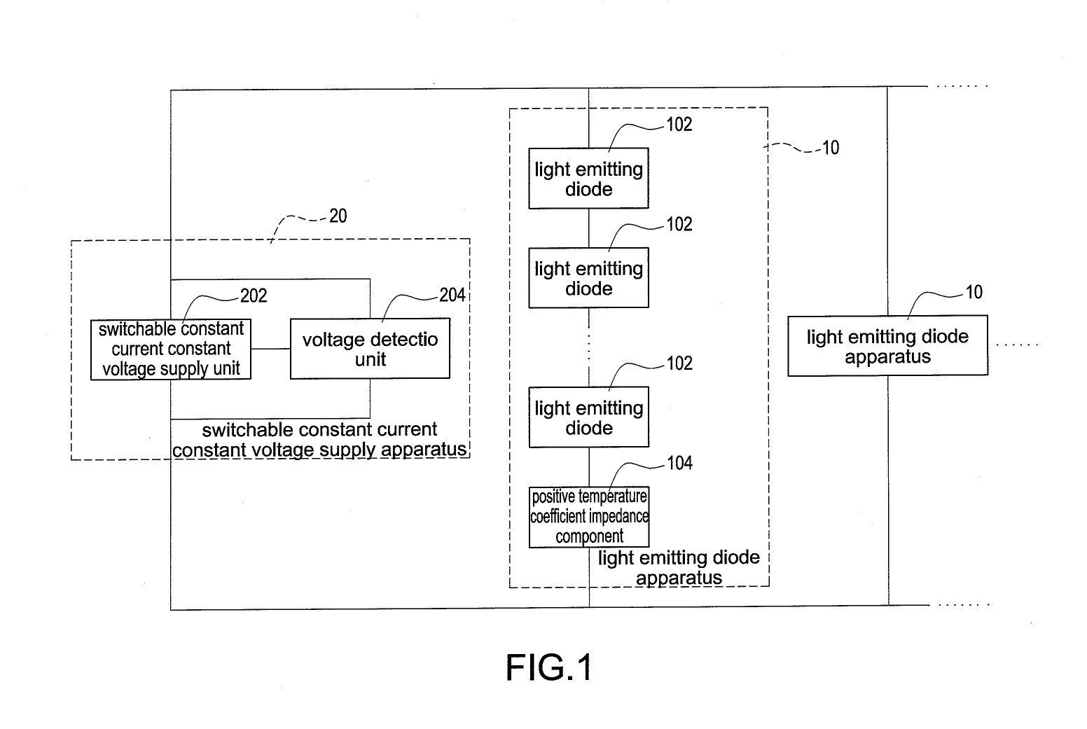

FIG. 1 shows a block diagram of the light emitting diode apparatus with over current protection function of the present invention. A light emitting diode apparatus 10 with over current protection function is applied to a switchable constant current constant voltage supply apparatus 20. The switchable constant current constant voltage supply apparatus 20 comprises a switchable constant current constant voltage supply unit 202 and a voltage detection unit 204.

The light emitting diode apparatus 10 comprise a plurality of light emitting diodes 102 and a positive temperature coefficient impedance component 104. The light emitting diodes 102 are connected in series and are electrically connected to the switchable constant current constant voltage supply unit 202 and the voltage detection unit 204. The positive temperature coefficient impedance component 104 is electrically connected to the switchable constant current constant voltage supply unit 202, the voltage detection unit 204 and the light emitting diode 102.

A plurality of the light emitting diode apparatuses 10 are connected in parallel and are electrically connected to the switchable constant current constant voltage supply unit 202 and the voltage detection unit 204. The voltage detection unit 204 detects a voltage of the light emitting diode apparatus 10 and then informs the switchable constant current constant voltage supply unit 202 of the detected voltage.

The switchable constant current constant voltage supply unit 202 outputs a constant current to drive the light emitting diode apparatuses 10 when the voltage of the light emitting diode apparatus 10 detected by the voltage detection unit 204 is not greater than a threshold voltage. The switchable constant current constant voltage supply unit 202 outputs a constant voltage to drive the light emitting diode apparatuses 10 when the voltage of the light emitting diode apparatus 10 detected by the voltage detection unit 204 is greater than the threshold voltage.

In another word, the switchable constant current constant voltage supply unit 202 outputs the constant current to drive the light emitting diode apparatuses 10 when the switchable constant current constant voltage supply unit 202 is in a normal condition (namely, all of the light emitting diode apparatuses 10 function normally and are not damaged). Then, temperatures of the other normal light emitting diode apparatuses 10 are increasing because the other normal light emitting diode apparatuses 10 have to share a current passing through a damaged light emitting diode apparatus 10 (namely, a current passing through the normal light emitting diode apparatus 10 is increasing) when one of the light emitting diode apparatuses 10 is damaged. Therefore, an impedance of the positive temperature coefficient impedance component 104 is increasing, so that the voltage of the light emitting diode apparatus 10 is increasing. The voltage detection unit 204 detects that the voltage of the light emitting diode apparatus 10 is increasing and then informs the switchable constant current constant voltage supply unit 202, so that the switchable constant current constant voltage supply unit 202 enters a constant voltage output mode to decrease the current passing through the light emitting diode apparatus 10 to protect the light emitting diode apparatus 10.

The positive temperature coefficient impedance component 104 is, for example but not limited to, a positive temperature coefficient thermistor or a polymeric positive temperature coefficient thermistor. The switchable constant current constant voltage supply unit 202 is, for example but not limited to, a switchable constant current constant voltage supply circuit. The voltage detection unit 204 is, for example but not limited to, a voltage detection circuit.

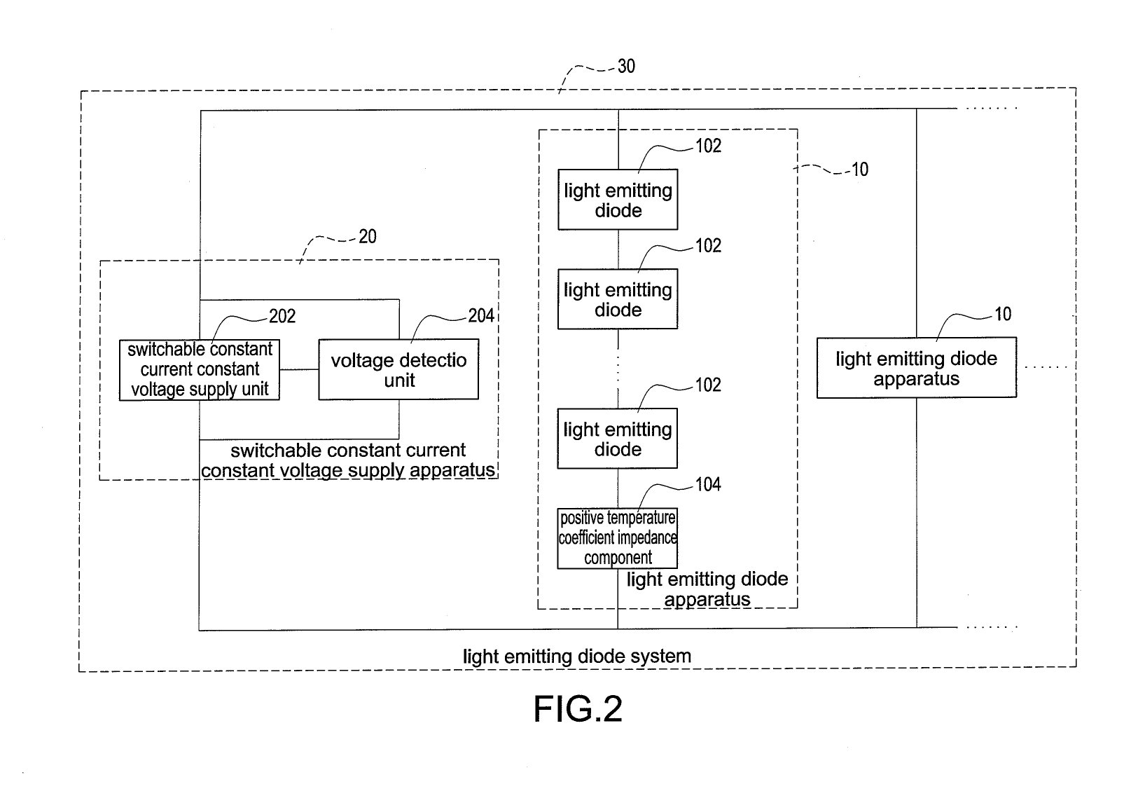

FIG. 2 shows a block diagram of the light emitting diode system with over current protection function of the present invention. A light emitting diode system 30 with over current protection function comprises a switchable constant current constant voltage supply apparatus 20 and a plurality of light emitting diode apparatuses 10 with over current protection function. The light emitting diode apparatuses 10 are connected in parallel and are electrically connected to the switchable constant current constant voltage supply apparatus 20.

The switchable constant current constant voltage supply apparatus 20 comprises a switchable constant current constant voltage supply unit 202 and a voltage detection unit 204. The switchable constant current constant voltage supply unit 202 is electrically connected to the light emitting diode apparatuses 10. The voltage detection unit 204 is electrically connected to the light emitting diode apparatuses 10 and the switchable constant current constant voltage supply unit 202.

The light emitting diode apparatus 10 comprise a plurality of light emitting diodes 102 and a positive temperature coefficient impedance component 104. The light emitting diodes 102 are connected in series and are electrically connected to the switchable constant current constant voltage supply unit 202 and the voltage detection unit 204. The positive temperature coefficient impedance component 104 is electrically connected to the switchable constant current constant voltage supply unit 202, the voltage detection unit 204 and the light emitting diode 102.

The voltage detection unit 204 detects a voltage of the light emitting diode apparatus 10 and then informs the switchable constant current constant voltage supply unit 202.

The switchable constant current constant voltage supply unit 202 outputs a constant current to drive the light emitting diode apparatuses 10 when the voltage of the light emitting diode apparatus 10 detected by the voltage detection unit 204 is not greater than a threshold voltage.

The switchable constant current constant voltage supply unit 202 outputs a constant voltage to drive the light emitting diode apparatuses 10 when the voltage of the light emitting diode apparatus 10 detected by the voltage detection unit 204 is greater than the threshold voltage.

The positive temperature coefficient impedance component 104 is, for example but not limited to, a positive temperature coefficient thermistor or a polymeric positive temperature coefficient thermistor. The switchable constant current constant voltage supply unit 202 is, for example but not limited to, a switchable constant current constant voltage supply circuit. The voltage detection unit 204 is, for example but not limited to, a voltage detection circuit.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light emitting diode apparatus with over current protection function, the light emitting diode apparatus applied to a switchable constant current constant voltage supply apparatus, the switchable constant current constant voltage supply apparatus comprising a switchable constant current constant voltage supply unit and a voltage detection unit, the light emitting diode apparatus comprising:
a plurality of light emitting diodes connected in series and electrically connected to the switchable constant current constant voltage supply unit and the voltage detection unit; and
a positive temperature coefficient impedance component electrically connected to the switchable constant current constant voltage supply unit, the voltage detection unit and the light emitting diode,
wherein a plurality of the light emitting diode apparatuses are connected in parallel and are electrically connected to the switchable constant current constant voltage supply unit and the voltage detection unit; the voltage detection unit detects a voltage of the light emitting diode apparatus and then informs the switchable constant current constant voltage supply unit of the detected voltage; the switchable constant current constant voltage supply unit outputs a constant current to drive the light emitting diode apparatuses when the voltage of the light emitting diode apparatus detected by the voltage detection unit is not greater than a threshold voltage; the switchable constant current constant voltage supply unit outputs a constant voltage to drive the light emitting diode apparatuses when the voltage of the light emitting diode apparatus detected by the voltage detection unit is greater than the threshold voltage.

2. The light emitting diode apparatus in claim 1, wherein the positive temperature coefficient impedance component is a positive temperature coefficient thermistor.

3. The light emitting diode apparatus in claim 1, wherein the positive temperature coefficient impedance component is a polymeric positive temperature coefficient thermistor.

4. The light emitting diode apparatus in claim 1, wherein the switchable constant current constant voltage supply unit is a switchable constant current constant voltage supply circuit.

5. The light emitting diode apparatus in claim 1, wherein the voltage detection unit is a voltage detection circuit.

6. A light emitting diode system with over current protection function, the light emitting diode system comprising:
a switchable constant current constant voltage supply apparatus; and
a plurality of light emitting diode apparatuses with over current protection function, the light emitting diode apparatuses connected in parallel and electrically connected to the switchable constant current constant voltage supply apparatus,
wherein the switchable constant current constant voltage supply apparatus comprises:
a switchable constant current constant voltage supply unit electrically connected to the light emitting diode apparatuses; and
a voltage detection unit electrically connected to the light emitting diode apparatuses and the switchable constant current constant voltage supply unit,
wherein the light emitting diode apparatus comprise:
a plurality of light emitting diodes connected in series and electrically connected to the switchable constant current constant voltage supply unit and the voltage detection unit; and
a positive temperature coefficient impedance component electrically connected to the switchable constant current constant voltage supply unit, the voltage detection unit and the light emitting diode,
wherein the voltage detection unit detects a voltage of the light emitting diode apparatus and then informs the switchable constant current constant voltage supply unit; the switchable constant current constant voltage supply unit outputs a constant current to drive the light emitting diode apparatuses when the voltage of the light emitting diode apparatus detected by the voltage detection unit is not greater than a threshold voltage; the switchable constant current constant voltage supply unit outputs a constant voltage to drive the light emitting diode apparatuses when the voltage of the light emitting diode apparatus detected by the voltage detection unit is greater than the threshold voltage.

7. The light emitting diode system in claim 6, wherein the positive temperature coefficient impedance component is a positive temperature coefficient thermistor.

8. The light emitting diode system in claim 6, wherein the positive temperature coefficient impedance component is a polymeric positive temperature coefficient thermistor.

9. The light emitting diode system in claim 6, wherein the switchable constant current constant voltage supply unit is a switchable constant current constant voltage supply circuit.

10. The light emitting diode system in claim 6, wherein the voltage detection unit is a voltage detection circuit.
